(19) United States
(12) Patent Application Publication
(10) Pub. No.: US 2010/0238801 A1
(43) Pub. Date: Sep. 23, 2010

(54) METHOD AND SYSTEM FOR STALE DATA DETECTION BASED QUALITY OF SERVICE

(76) Inventors: Donald L. Smith, Satellite Beach, FL (US); Anthony P. Galluscio, Indialantic, FL (US); Robert J. Knazik, Cocoa Beach, FL (US)

Correspondence Address: HARRIS CORPORATION;C/O MCANDREWS HELD & MALLOY, 500 WEST MADISON, CHICAGO, IL, 60661, US

(21) Appl. No.: 11/461,082

(22) Filed: Jul. 31, 2006

(51) Int. Cl. H04L 12/26

(52) U.S. Cl. 370/229

(57) ABSTRACT

Certain embodiments of the present invention provide for a system and method for controlling the quality of service for data communication. The method includes reviewing a timestamp of a data set, the timestamp having a time value. The time value may be the time the data set expires. Alternatively, the time value may be the time the data set was acquired. In yet another alternative, the time stamp may include both the time the data set expires and the time the data set was acquired. Next, the method includes determining if the time value of the time stamp is greater than the current time. If the time value is the time the data set expires and the time stamp is greater than the current time, the data set has become stale and is dropped.

### BACKGROUND OF THE INVENTION

The presently described technology generally relates to communications networks. More particularly, the presently described technology relates to systems and methods for controlling the Quality of Service for data communication.

Communications networks are utilized in a variety of environments. Communications networks typically include two or more nodes connected by one or more links. Generally, a communications network is used to support communication between two or more participant nodes over the links and intermediate nodes in the communications network. There may be many kinds of nodes in the network. For example, a network may include nodes such as clients, servers, workstations, switches, and/or routers. Links may be, for example, modem connections over phone lines, wires, Ethernet links, Asynchronous Transfer Mode (ATM) circuits, satellite links, and/or fiber optic cables.

A communications network may actually be composed of one or more smaller communications networks. For example, the Internet is often described as network of interconnected computer networks. Each network may utilize a different architecture and/or topology. For example, one network may be a switched Ethernet network with a star topology and another network may be a Fiber-Distributed Data Interface (FDDI) ring.

Communications networks may carry a wide variety of data. For example, a network may carry bulk file transfers alongside data for interactive real-time conversations. The data sent on a network is often sent in packets, cells, or frames. Alternatively, data may be sent as a stream. In some instances, a stream or flow of data may actually be a sequence of packets. Networks such as the Internet provide general purpose data paths between a range of nodes and carrying a vast array of data with different requirements.

Communication over a network typically involves multiple levels of communication protocols. A protocol stack, also referred to as a networking stack or protocol suite, refers to a collection of protocols used for communication. Each protocol may be focused on a particular type of capability or form of communication. For example, one protocol may be concerned with the electrical signals needed to communicate with devices connected by a copper wire. Other protocols may address ordering and reliable transmission between two nodes separated by many intermediate nodes, for example.

Protocols in a protocol stack typically exist in a hierarchy. Often, protocols are classified into layers. One reference model for protocol layers is the Open Systems Interconnection (OSI) model. The OSI reference model includes seven layers: a physical layer, data link layer, network layer, transport layer, session layer, presentation layer, and application layer. The physical layer is the “lowest” layer, while the application layer is the “highest” layer. Two well-known transport layer protocols are the Transmission Control Protocol (TCP) and User Datagram Protocol (UDP). A well known network layer protocol is the Internet Protocol (IP).

At the transmitting node, data to be transmitted is passed down the layers of the protocol stack, from highest to lowest. Conversely, at the receiving node, the data is passed up the layers, from lowest to highest. At each layer, the data may be manipulated by the protocol handling communication at that layer. For example, a transport layer protocol may add a header to the data that allows for ordering of packets upon arrival at a destination node. Depending on the application, some layers may not be used, or even present, and data may just be passed through.

One kind of communications network is a tactical data network. A tactical data network may also be referred to as a tactical communications network. A tactical data network may be utilized by units within an organization such as a military (e.g., army, navy, and/or air force). Nodes within a tactical data network may include, for example, individual soldiers, aircraft, command units, satellites, and/or radios. A tactical data network may be used for communicating data such as voice, position telemetry, sensor data, and/or real-time video.

An example of how a tactical data network may be employed is as follows. A logistics convoy may be in-route to provide supplies for a combat unit in the field. Both the convoy and the combat unit may be providing position telemetry to a command post over satellite radio links. An unmanned aerial vehicle (UAV) may be patrolling along the road the convoy is taking and transmitting real-time video data to the command post over a satellite radio link also. At the command post, an analyst may be examining the video data while a controller is tasking the UAV to provide video for a specific section of road. The analyst may then spot an improvised explosive device (IED) that the convoy is approaching and send out an order over a direct radio link to the convoy for it to halt and alerting the convoy to the presence of the IED.

The various networks that may exist within a tactical data network may have many different architectures and characteristics. For example, a network in a command unit may include a gigabit Ethernet local area network (LAN) along with radio links to satellites and field units that operate with much lower throughput and higher latency. Field units may communicate both via satellite and via direct path radio frequency (RF). Data may be sent point-to-point, multicast, or broadcast, depending on the nature of the data and/or the specific physical characteristics of the network. A network may include radios, for example, set up to relay data. In addition, a network may include a high frequency (HF) network which allows long range communication. A microwave network may also be used, for example. Due to the diversity of the types of links and nodes, among other reasons, tactical networks often have overly complex network addressing schemes and routing tables. In addition, some networks, such as radio-based networks, may operate using bursts. That is, rather than continuously transmitting data, they send periodic bursts of data. This is useful because the radios are broadcasting on a particular channel that is shared by participants, and one radio may transmit at a time.

Tactical data networks are generally bandwidth-constrained. That is, there is typically more data to be communicated than bandwidth available at any given point in time. These constraints may be due to either the demand for bandwidth exceeding the supply, and/or the available communications technology not supplying enough bandwidth to meet the user's needs, for example. For example, between some nodes, bandwidth may be on the order of kilobits/sec. In bandwidth-constrained tactical data networks, less important data can clog the network, preventing more important data from getting through in a timely fashion, or even arriving at a receiving node at all. In addition, portions of the networks may include internal buffering to compensate for unreliable links. This may cause additional delays. Further, when the buffers get full, data may be dropped.

In many instances the bandwidth available to a network cannot be increased. For example, the bandwidth available over a satellite communications link may be fixed and cannot effectively be increased without deploying another satellite. In these situations, bandwidth must be managed rather than simply expanded to handle demand. In large systems, network bandwidth is a critical resource. It is desirable for applications to utilize bandwidth as efficiently as possible. In addition, it is desirable that applications avoid “clogging the pipe,” that is, overwhelming links with data, when bandwidth is limited. When bandwidth allocation changes, applications should preferably react. Bandwidth can change dynamically due to, for example, quality of service, jamming, signal obstruction, priority reallocation, and line-of-sight. Networks can be highly volatile and available bandwidth can change dramatically and without notice.

In addition to bandwidth constraints, tactical data networks may experience high latency. For example, a network involving communication over a satellite link may incur latency on the order of half a second or more. For some communications this may not be a problem, but for others, such as real-time, interactive communication (e.g., voice communications), it is highly desirable to minimize latency as much as possible.

Another characteristic common to many tactical data networks is data loss. Data may be lost due to a variety of reasons. For example, a node with data to send may be damaged or destroyed. As another example, a destination node may temporarily drop off of the network. This may occur because, for example, the node has moved out of range, the communication's link is obstructed, and/or the node is being jammed. Data may be lost because the destination node is not able to receive it and intermediate nodes lack sufficient capacity to buffer the data until the destination node becomes available. Additionally, intermediate nodes may not buffer the data at all, instead leaving it to the sending node to determine if the data ever actually arrived at the destination.

Often, applications in a tactical data network are unaware of and/or do not account for the particular characteristics of the network. For example, an application may simply assume it has as much bandwidth available to it as it needs. As another example, an application may assume that data will not be lost in the network. Applications which do not take into consideration the specific characteristics of the underlying communications network may behave in ways that actually exacerbate problems. For example, an application may continuously send a stream of data that could just as effectively be sent less frequently in larger bundles. The continuous stream may incur much greater overhead in, for example, a broadcast radio network that effectively starves other nodes from communicating, whereas less frequent bursts would allow the shared bandwidth to be used more effectively.

Certain protocols do not work well over tactical data networks. For example, a protocol such as TCP may not function well over a radio-based tactical network because of the high loss rates and latency such a network may encounter. TCP requires several forms of handshaking and acknowledgments to occur in order to send data. High latency and loss may result in TCP hitting time outs and not being able to send much, if any, meaningful data over such a network.

Information communicated with a tactical data network often has various levels of priority with respect to other data in the network. For example, threat warning receivers in an aircraft may have higher priority than position telemetry information for troops on the ground miles away. As another example, orders from headquarters regarding engagement may have higher priority than logistical communications behind friendly lines. The priority level may depend on the particular situation of the sender and/or receiver. For example, position telemetry data may be of much higher priority when a unit is actively engaged in combat as compared to when the unit is merely following a standard patrol route. Similarly, real-time video data from an UAV may have higher priority when it is over the target area as opposed to when it is merely in-route.

There are several approaches to delivering data over a network. One approach, used by many communications networks, is a “best effort” approach. That is, data being communicated will be handled as well as the network can, given other demands, with regard to capacity, latency, reliability, ordering, and errors. Thus, the network provides no guarantees that any given piece of data will reach its destination in a timely manner, or at all. Additionally, no guarantees are made that data will arrive in the order sent or even without transmission errors changing one or more bits in the data.

Another approach is Quality of Service (QoS). QoS refers to one or more capabilities of a network to provide various forms of guarantees with regard to data that is carried. For example, a network supporting QoS may guarantee a certain amount of bandwidth to a data stream. As another example, a network may guarantee that packets between two particular nodes have some maximum latency. Such a guarantee may be useful in the case of a voice communication where the two nodes are two people having a conversation over the network. Delays in data delivery in such a case may result in irritating gaps in communication and/or dead silence, for example.

QoS may be viewed as the capability of a network to provide better service to selected network traffic. The primary goal of QoS is to provide priority including dedicated bandwidth, controlled jitter and latency (required by some real-time and interactive traffic), and improved loss characteristics. Another important goal is making sure that providing priority for one flow does not make other flows fail. That is, guarantees made for subsequent flows must not break the guarantees made to existing flows.

Current approaches to QoS often require every node in a network to support QoS, or, at the very least, for every node in the network involved in a particular communication to support QoS. For example, in current systems, in order to provide a latency guarantee between two nodes, every node carrying the traffic between those two nodes must be aware of and agree to honor, and be capable of honoring, the guarantee.

There are several approaches to providing QoS. One approach is Integrated Services, or “IntServ.” IntServ provides a QoS system wherein every node in the network supports the services and those services are reserved when a connection is set up. IntServ does riot scale well because of the large amount of state information that must be maintained at every node and the overhead associated with setting up such connections.

Another approach to providing QoS is Differentiated Services, or “DiffServ.” DiffServ is a class of service model that enhances the best-effort services of a network such as the Internet. DiffServ differentiates traffic by user, service requirements, and other criteria. Then, DiffServ marks packets so that network nodes can provide different levels of service via priority queuing or bandwidth allocation, or by choosing dedicated routes for specific traffic flows. Typically, a node has a variety of queues for each class of service. The node then selects the next packet to send from those queues based on the class categories.

Existing QoS solutions are often network specific and each network type or architecture may require a different QoS configuration. Due to the mechanisms existing QoS solutions utilize, messages that look the same to current QoS systems may actually have different priorities based on message content. However, data consumers may require access to high-priority data without being flooded by lower-priority data. Existing QoS systems cannot provide QoS based on message content at the transport layer.

As mentioned, existing QoS solutions require at least the nodes involved in a particular communication to support QoS. However, the nodes at the “edge” of network may be adapted to provide some improvement in QoS, even if they are incapable of making total guarantees. Nodes are considered to be at the edge of the network if they are the participating nodes in a communication (i.e., the transmitting and/or receiving nodes) and/or if they are located at chokepoints in the network. A chokepoint is a section of the network where all traffic must pass to another portion. For example, a router or gateway from a LAN to a satellite link would be a choke point, since all traffic from the LAN to any nodes not on the LAN must pass through the gateway to the satellite link.

Thus, there is a need for systems and methods providing QoS in a tactical data network. There is a need for systems and methods for providing QoS on the edge of a tactical data network. Additionally, there is a need for adaptive, configurable QoS systems and methods in a tactical data network.

### BRIEF SUMMARY OF THE INVENTION

Certain embodiments of the present invention provide for a method for controlling the quality of service for data communication. The method includes reviewing a timestamp of a data set. The timestamp has a time value. Next, the method includes determining if the time value of the time stamp is greater than the current time. If the time value of the time stamp is greater than the current time, the method includes dropping the data set.

Certain embodiments of the present invention provide for a method for controlling the quality of service for data communication. The method includes reviewing a timestamp of the data set. The timestamp has a time value. The method also includes reviewing an identifier of a data set for associating the data set with one of a plurality of groups. Each of the groups being associated with a predetermined threshold time value. The method also includes calculating the difference between the time value of the time stamp and the current time. Finally, the method includes dropping the data set if the difference between the time value of the time stamp and the current time exceeds a predetermined threshold time value.

Certain embodiments of the present invention provide for a computer-readable medium having a set of instructions for execution on a processing device. The set of instructions includes a reviewing routine for reviewing a timestamp of a data set, said timestamp having a time value. The set of instructions also includes a comparing routine for determining if the value of the timestamp is greater than the current time. The set of instructions also includes a dropping routine for dropping the data set if the current time exceeds the time value of the timestamp.

### BRIEF DESCRIPTION OF SEVERAL VIEWS OF THE DRAWINGS

FIG. 1 illustrates a tactical communications network environment operating with an embodiment of the present invention.

FIG. 2 shows the positioning of the data communications system in the seven layer OSI network model in accordance with an embodiment of the present invention.

FIG. 3 depicts an example of multiple networks facilitated using the data communications system in accordance with an embodiment of the present invention.

FIG. 4 illustrates a data communication environment operating with an embodiment of the present invention.

FIG. 5 illustrates a data communication environment operating with an embodiment of the present invention.

FIG. 6 illustrates a flow diagram in accordance with an embodiment of the present invention.

FIG. 7 illustrates a flow diagram in accordance with an embodiment of the present invention.

FIG. 8 illustrates a method in accordance with an embodiment of the present invention.

FIG. 9 illustrates a method in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

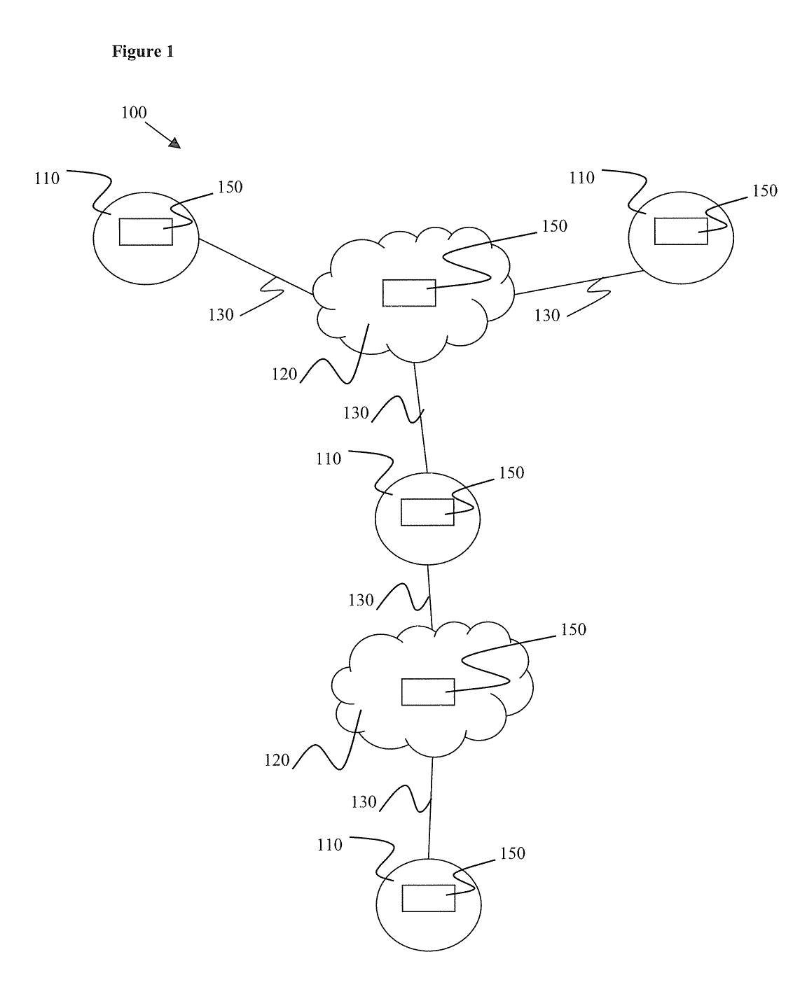

FIG. 1 illustrates a tactical communications network environment 100 operating with an embodiment of the present invention. The network environment 100 includes a plurality of communication nodes 110, one or more networks 120, one or more links 130 connecting the nodes and network(s), and one or more communication systems 150 facilitating communication over the components of the network environment 100. The following discussion assumes a network environment 100 including more than one network 120 and more than one link 130, but it should be understood that other environments are possible and anticipated.

Communication nodes 110 may be and/or include radios, transmitters, satellites, receivers, workstations, servers, and/or other computing or processing devices, for example.

Network(s) 120 may be hardware and/or software for transmitting data between nodes 110, for example. Network(s) 120 may include one or more nodes 110, for example.

Link(s) 130 may be wired and/or wireless connections to allow transmissions between nodes 110 and/or network(s) 120.

The communications system 150 may include software, firmware, and/or hardware used to facilitate data transmission among the nodes 110, networks 120, and links 130, for example. As illustrated in FIG. 1, communications system 150 may be implemented with respect to the nodes 110, network(s) 120, and/or links 130. In certain embodiments, every node 110 includes a communications system 150. In certain embodiments, one or more nodes 110 include a communications system 150. In certain embodiments, one or more nodes 110 may not include a communications system 150.

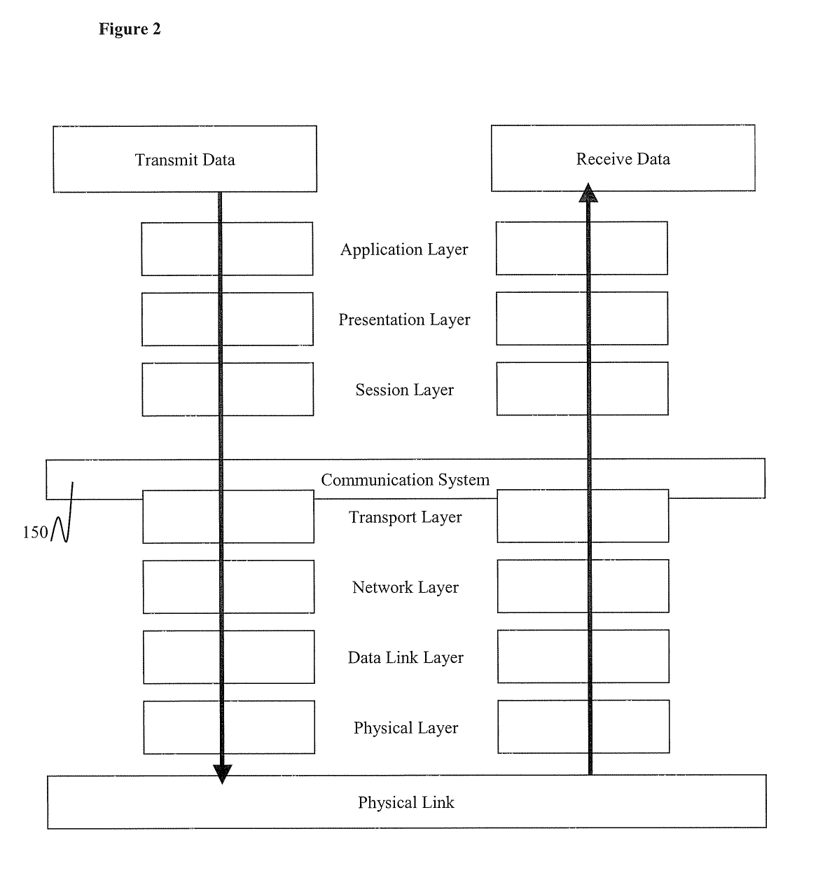

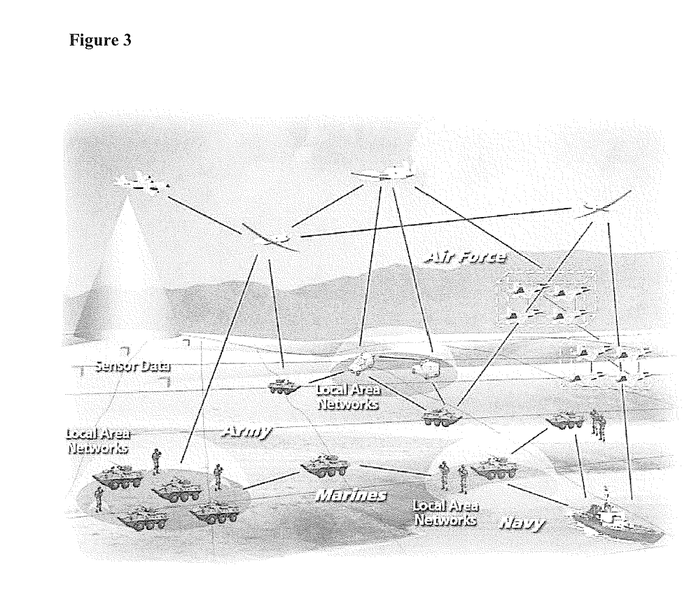

The communication system 150 provides dynamic management of data to help assure communications on a tactical communications network, such as the network environment 100. As shown in FIG. 2, in certain embodiments, the system 150 operates as part of and/or at the top of the transport layer in the OSI seven layer protocol model. The system 150 may give precedence to higher priority data in the tactical network passed to the transport layer, for example. The system 150 may be used to facilitate communications in a single network, such as a local area network (LAN) or wide area network (WAN), or across multiple networks. An example of a multiple network system is shown in FIG. 3. The system 150 may be used to manage available bandwidth rather than add additional bandwidth to the network, for example.

In certain embodiments, the system 150 is a software system, although the system 150 may include both hardware and software components in various embodiments. The system 150 may be network hardware independent, for example. That is, the system 150 may be adapted to function on a variety of hardware and software platforms. In certain embodiments, the system 150 operates on the edge of the network rather than on nodes in the interior of the network. However, the system 150 may operate in the interior of the network as well, such as at “choke points” in the network.

The system 150 may use rules and modes or profiles to perform throughput management functions such as optimizing available bandwidth, setting information priority, and managing data links in the network. Optimizing bandwidth usage may include removing functionally redundant messages, message stream management or sequencing, and message compression, for example. By “optimizing” bandwidth, it is meant that the presently described technology can be employed to increase an efficiency of bandwidth use to communicate data in one or more networks. Setting information priority may include differentiating message types at a finer granularity than Internet Protocol (IP) based techniques and sequencing messages onto a data stream via a selected rule-based sequencing algorithm, for example. Data link management may include rule-based analysis of network measurements to affect changes in rules, modes, and/or data transports, for example. A mode or profile may include a set of rules related to the operational needs for a particular network state of health or condition. The system 150 provides dynamic, “on-the-fly” reconfiguration of modes, including defining and switching to new modes on the fly.

The communication system 150 may be configured to accommodate changing priorities and grades of service, for example, in a volatile, bandwidth-limited network. The system 150 may be configured to manage information for improved data flow to help increase response capabilities in the network and reduce communications latency. Additionally, the system 150 may provide interoperability via a flexible architecture that is upgradeable and scalable to improve availability, survivability, and reliability of communications. The system 150 supports a data communications architecture that may be autonomously adaptable to dynamically changing environments while using predefined and predictable system resources and bandwidth, for example.

In certain embodiments, the system 150 provides throughput management to bandwidth-constrained tactical communications networks while remaining transparent to applications using the network. The system 150 provides throughput management across multiple users and environments at reduced complexity to the network. As mentioned above, in certain embodiments, the system 150 runs on a host node in and/or at the top of layer four (the transport layer) of the OSI seven layer model and does not require specialized network hardware. The system 150 may operate transparently to the layer four interface. That is, an application may utilize a standard interface for the transport layer and be unaware of the operation of the system 150. For example, when an application opens a socket, the system 150 may filter data at this point in the protocol stack. The system 150 achieves transparency by allowing applications to use, for example, the TCP/IP socket interface that is provided by an operating system at a communication device on the network rather than an interface specific to the system 150. System 150 rules may be written in extensible markup language (XML) and/or provided via custom dynamic link libraries (DLLs), for example.

In certain embodiments, the system 150 provides quality of service (QoS) on the edge of the network. The system's QoS capability offers content-based, rule-based data prioritization on the edge of the network, for example. Prioritization may include differentiation and/or sequencing, for example. The system 150 may differentiate messages into queues based on user-configurable differentiation rules, for example. The messages are sequenced into a data stream in an order dictated by the user-configured sequencing rule (e.g., starvation, round robin, relative frequency, etc.). Using QoS on the edge, data messages that are indistinguishable by traditional QoS approaches may be differentiated based on message content, for example. Rules may be implemented in XML, for example. In certain embodiments, to accommodate capabilities beyond XML and/or to support extremely low latency requirements, the system 150 allows dynamic link libraries to be provided with custom code, for example.

Inbound and/or outbound data on the network may be customized via the system 150. Prioritization protects client applications from high-volume, low-priority data, for example. The system 150 helps to ensure that applications receive data to support a particular operational scenario or constraint.

In certain embodiments, when a host is connected to a LAN that includes a router as an interface to a bandwidth-constrained tactical network, the system may operate in a configuration known as QoS by proxy. In this configuration, packets that are bound for the local LAN bypass the system and immediately go to the LAN. The system applies QoS on the edge of the network to packets bound for the bandwidth-constrained tactical link.

In certain embodiments, the system 150 offers dynamic support for multiple operational scenarios and/or network environments via commanded profile switching. A profile may include a name or other identifier that allows the user or system to change to the named profile. A profile may also include one or more identifiers, such as a functional redundancy rule identifier, a differentiation rule identifier, an archival interface identifier, a sequencing rule identifier, a pre transmit interface identifier, a post-transmit interface identifier, a transport identifier, and/or other identifier, for example. A functional redundancy rule identifier specifies a rule that detects functional redundancy, such as from stale data or substantially similar data, for example. A differentiation rule identifier specifies a rule that differentiates messages into queues for processing, for example. An archival interface identifier specifies an interface to an archival system, for example. A sequencing rule identifier identifies a sequencing algorithm that controls samples of queue fronts and, therefore, the sequencing of the data on the data stream. A pre-transmit interface identifier specifies the interface for pre-transmit processing, which provides for special processing such as encryption and compression, for example. A post-transmit interface identifier identifies an interface for post-transmit processing, which provides for processing such as de-encryption and decompression, for example. A transport identifier specifies a network interface for the selected transport.

A profile may also include other information, such as queue sizing information, for example. Queue sizing information identifiers a number of queues and amount of memory and secondary storage dedicated to each queue, for example.

In certain embodiments, the system 150 provides a rules-based approach for optimizing bandwidth. For example, the system 150 may employ queue selection rules to differentiate messages into message queues so that messages may be assigned a priority and an appropriate relative frequency on the data stream. The system 150 may use functional redundancy rules to manage functionally redundant messages. A message is functionally redundant if it is not different enough (as defined by the rule) from a previous message that has not yet been sent on the network, for example. That is, if a new message is provided that is not sufficiently different from an older message that has already been scheduled to be sent, but has not yet been sent, the newer message may be dropped, since the older message will carry functionally equivalent information and is further ahead in the queue. In addition, functional redundancy many include actual duplicate messages and newer messages that arrive before an older message has been sent. For example, a node may receive identical copies of a particular message due to characteristics of the underlying network, such as a message that was sent by two different paths for fault tolerance reasons. As another example, a new message may contain data that supersedes an older message that has not yet been sent. In this situation, the system 150 may drop the older message and send only the new message. The system 150 may also include priority sequencing rules to determine a priority-based message sequence of the data stream. Additionally, the system 150 may include transmission processing rules to provide pre-transmission and post-transmission special processing, such as compression and/or encryption.

In certain embodiments, the system 150 provides fault tolerance capability to help protect data integrity and reliability. For example, the system 150 may use user-defined queue selection rules to differentiate messages into queues. The queues are sized according to a user-defined configuration, for example. The configuration specifies a maximum amount of memory a queue may consume, for example. Additionally, the configuration may allow the user to specify a location and amount of secondary storage that may be used for queue overflow. After the memory in the queues is filled, messages may be queued in secondary storage. When the secondary storage is also full, the system 150 may remove the oldest message in the queue, logs an error message, and queues the newest message. If archiving is enabled for the operational mode, then the de-queued message may be archived with an indicator that the message was not sent on the network.

Memory and secondary storage for queues in the system 150 may be configured on a per-link basis for a specific application, for example. A longer time between periods of network availability may correspond to more memory and secondary storage to support network outages. The system 150 may be integrated with network modeling and simulation applications, for example, to help identify sizing to help ensure that queues are sized appropriately and time between outages is sufficient to help achieve steady-state and help avoid eventual queue overflow.

Furthermore, in certain embodiments, the system 150 offers the capability to meter inbound (“shaping”) and outbound (“policing”) data. Policing and shaping capabilities help address mismatches in timing in the network. Shaping helps to prevent network buffers form flooding with high-priority data queued up behind lower-priority data. Policing helps to prevent application data consumers from being overrun by low-priority data. Policing and shaping are governed by two parameters: effective link speed and link proportion. The system 150 may from a data stream that is no more than the effective link speed multiplied by the link proportion, for example. The parameters may be modified dynamically as the network changes. The system may also provide access to detected link speed to support application level decisions on data metering. Information provided by the system 150 may be combined with other network operations information to help decide what link speed is appropriate for a given network scenario.

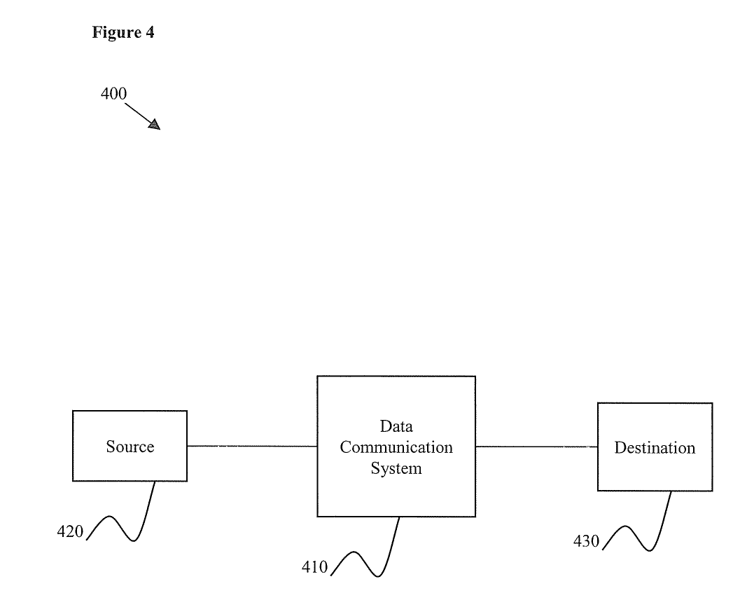

FIG. 4 illustrates a data communication environment 400 operating with an embodiment of the present invention. The environment 400 includes one or more source nodes 420, a data communication system 410, and one or more destination nodes 430. The data communication system 410 is in communication with the source node(s) 420 and the destination node(s) 430. The data communication system 410 may communicate with the source node(s) 420 and/or destination node(s) 430 over links, such as wire, radio, satellite, network links, and/or through inter-process communication, for example. In certain embodiments, the data communication system 410 may communicate with one or more source nodes 420 and/or destination nodes 430 over one or more tactical data networks. The components of the system 400 may be single units, separate units, may be integrated in various forms, and may be implemented in hardware and/or in software.

The data communication system 410 may be similar to the communication system 150, described above, for example. In certain embodiments, the data communication system 410 is adapted to receive data from the one or more source nodes 420. In certain embodiments, the data communication system 410 may include a memory unit and/or data base for storing computer instructions and rules. The data communication system 410 may also include a processor for processing data, rules, and instructions. In certain embodiments, the data communication system 410 may include one or more queues for storing, organizing, and/or prioritizing the data. Alternatively, other data structures may be used for storing, organizing, and/or prioritizing the data. For example, a table, tree, or linked list may be used. In certain embodiments, the data communication system 410 is adapted to communicate data to the one or more destination nodes 430.

In certain embodiments, the data communication system 410 is transparent to other applications. For example, the processing, organizing, and/or prioritization performed by the data communication system 410 may be transparent to one or more source nodes 420 or other applications or data sources. For example, an application running on the same system as data communication system 410, or on a source node 420 connected to the data communication system 410, may be unaware of the prioritization of data performed by the data communication system 410.

The components, elements, and/or functionality of the data communication system 410 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

The source node 420 may include a sensor or measurement device to collect data or telemetry information. For example, the source node 420 may be a Global Positional System sensor to indicate positional data for a mobile vehicle, such as a tank, humvee unit, personal transporter, or individual solder. In another example, the source node 420 may be a photography unit, such as a video or still picture camera that acquires video or images. In another example, the source node may be a communication module, such as a radio or microphone. The destination node 430 may be any device or system interested in the data acquired by the source node 420. For example, the destination node 430 may be a receiver, a central computer system, and/or computers utilized by a command post or reconnaissance unit.

The data received, stored, prioritized, processed, communicated and/or transmitted by data communication system 410 may include a block of data. The block of data may be, for example, a packet, cell, frame, and/or stream. For example, the data communication system 410 may receive packets of data from a source node 420. As another example, the data communication system 410 may process a stream of data from a source node 420.

In certain embodiments, the data includes protocol information. The protocol information may be used by one or more protocols to communicate the data, for example. The protocol information may include, for example, a source address, a destination address, a source port, a destination port, and/or a protocol type. The source and/or destination address may be an IP address, for example, of a source node 420 and/or a destination node 430. The protocol type may include the kind of protocol used for one or more layers of communication of the data. For example, the protocol type may be a transport protocol such as Transmission Control Protocol (TCP), User Datagram Protocol (UDP), or Stream Control Transmission Protocol (SCTP). As another example, the protocol type may include Internet Protocol (IP), Internetwork Packet Exchange (IPX), Ethernet, Asynchronous Transfer Mode (ATM), File Transfer Protocol (FTP), and/or Real-time Transport Protocol (RTP). In certain embodiments, the data may also include time stamp information. The time stamp information may indicate, for example, the time of data acquisition by the source node 420. The timestamp information may also indicate, for example, the time the data expires, or becomes “stale.”

In certain embodiments, the data includes a header and a payload. The header may include some or all of the protocol information and the time stamp information, for example. In certain embodiments, some or all of the protocol information and the time stamp information is included in the payload. For example, protocol information may include information regarding a higher-level protocol stored in the payload portion of a block of data. In certain embodiments, the data is not contiguous in memory. That is, one or more portions of the data may be located in different regions of memory. For example, protocol information may be stored in one region of memory while the payload is stored in another buffer, and the time stamp information is stored in yet another buffer.

In an embodiment, the source node 420 and the data communication system 410 may be part of the same mobile unit. A mobile unit may be a tank, humvee unit, personal transporter, individual solder, unmanned aerial vehicle (UAV), or other mobile unit. A tank may have a GPS sensor to indicate positional data as a source unit 420. The positional data may be communicated to the data communication system 410. The data communication system 410 may be located on the tank. The data communication system 410 may prepare the data for communication to the destination node 430. As part of the preparation for communication to the destination node, the data communication system 410 may execute some form of network access protocol. The network access protocol may include requesting network access from a control unit, sensing carrier availability, or other form of access control.

In an example, the network for which the data communication system 410 is attempting to acquire access may be bandwidth-constrained. In addition, one or more links may be unreliable and/or intermittently disconnected. Accordingly, the data communication system 410 may temporarily queue data received from the source 420 until the data communication system 410 has been able to access the network to communicate the data to the destination 430. For example, the source 420 may acquire a data set. The source 420 may communicate the data set to the data communication system 410. The data communication system 410 may not currently have network access to transmit the data set to the destination 430. The data set may then be temporarily queued in a queue until the data communication system 410 has network access. If the data is the type in which the timing of the data is relevant, the amount of time the data spends in the queue may affect the relevance of the data. For example, if the data set is real time data, the data set may spend so much time in a queue prior to transmission as to render the data set irrelevant. In other words, the data set may become “stale.” In another example, the time between acquisition of the data set and transmission may be relatively large, rendering the data set irrelevant and thus “stale.” Transmission of a stale data set to the destination 430 may unnecessarily consume network bandwidth.

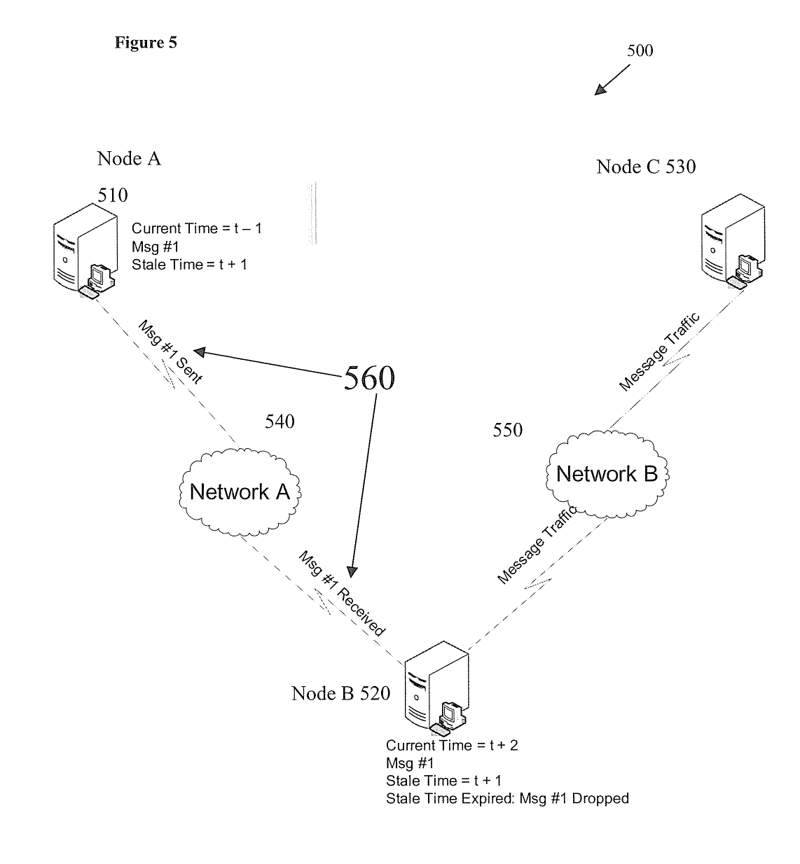

FIG. 5 illustrates a data communication environment 500 operating with an embodiment of the present invention. In the environment 500, three nodes are illustrated, Node A 510, Node B 520, and Node C 530. In addition, two networks are illustrated that connect the nodes A, B, and C. Network A 540 connects Nodes A 510 and B 520 and Network B 550 connects Nodes B 520 and C 530. The Nodes A, B, and C 510-530 respectively and Networks A 540 and Network B 550 may represent the system 400. For example, the Node A 510 and Network A 540 may represent a source 420 and data communication system 410. Node B may represent a destination 430. The Nodes A-C 510-530 may be any data acquisition, transmission, or reception hardware, software, and/or firmware. The Networks A and B 540, 550 may be any networking hardware, software, and/or firmware.

In an illustrative embodiment, Node A 510 may acquire a data set message #1 560, hereinafter data set 560. The data set 560 may be acquired at a current time of t−1. In an embodiment, the current time of acquisition t−1 may be included in the timestamp of the data set 560. Alternatively, the timestamp of data set 560 may include the “stale” time for the data set. The “stale” time may indicate the time in that the data set will become irrelevant, i.e. expires. The time the data set expires may be based on the selected mode. In an embodiment, the mode may be selected by a user. In another embodiment, the mode may be selected dynamically based on network conditions. In the example shown in FIG. 5, the “stale” time for data set 560 is t+1. In yet another alternative embodiment, the timestamp may include both the current time of acquisition and the “stale” time of the data set.

As shown in FIG. 5, the data set 560 may be communicated over Network A 540 and received by Node B 520. As shown in FIG. 5, prior to Node B 520 transmitting data set 560 to Node C 530, the timestamp of the data set 560 is reviewed. In the illustrated embodiment of FIG. 5, the timestamp of the data set 560 includes the stale data time for data set 560. The timestamp indicates that the stale data time for the data set 560 is t+1. Once the stale data time is obtained, the Node B 520 may evaluate its own internal clock for the current time. A comparison of the current time with the stale time may yield a determination of whether the data set 560 is stale data.

In the embodiment shown in FIG. 5, the Node B 520 compares the stale data time (t+1) of the data set 560 with the current time (t+2). As the current time of t+2 is greater than the stale data time of t+1, the data set 560 has expired. Accordingly, the data set 560 is deemed “stale” and is dropped from transmission from Node B. In an embodiment, the data set is dropped from the transmission queue.

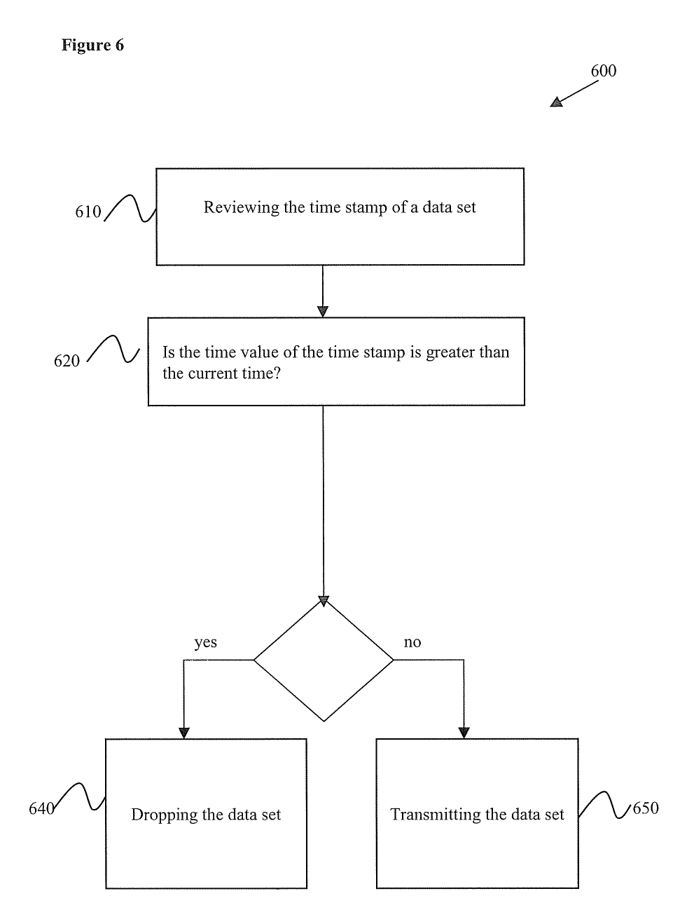

FIG. 6 illustrates a flow diagram 600 in accordance with an embodiment of the present invention. At step 610, the time stamp of the data set is reviewed. In the embodiment represented in the flow diagram 600, the time stamp may represent the time the data expires or becomes “stale.” The time the data set expires may be based on the selected mode. In an embodiment, the mode may be selected by a user. In another embodiment, the mode may be selected dynamically based on network conditions. The stale time may be compared with the current time to determine if the data is expired. At step 620, the value of the time stamp is compared to the current time. If the current time is less than the time value of the time stamp, then the data set is not stale, and the flow diagram proceeds to step 650. At step 650 the data set is transmitted. If the current time is greater than the value of the time stamp, the data set is stale and the flow diagram proceeds to step 640. At step 640, the data set is dropped and not transmitted.

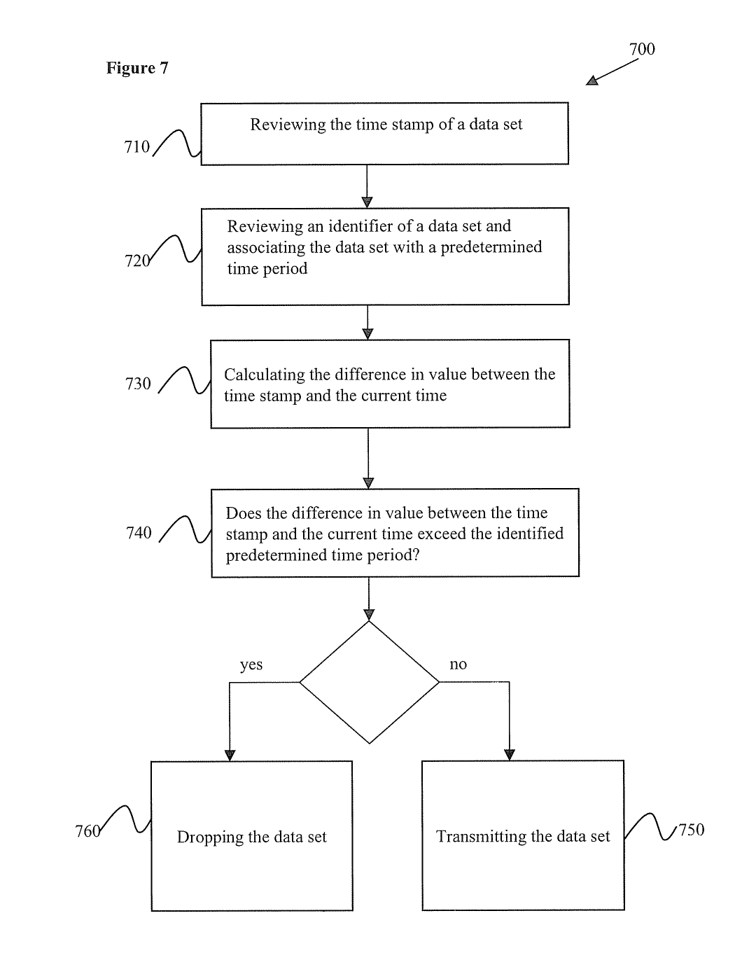

FIG. 7 illustrates a flow diagram 700 in accordance with an embodiment of the present invention. In the embodiment represented in the flow diagram 700, the time stamp may represent the time the data was “acquired” from the source. In the embodiment in which the time stamp represents the time the data was acquired from the source, the data set may include a field for identifying which group the data set belongs. For example, if the data set belongs to a group having real time data, such as positional data, the expiration time of the data may be relatively short. If the data set belongs to a group having non-real time data, such as periodic status reports, the expiration time of the data may be relatively long. The identifier field of the data set may indicate to which group it belongs, and a receiver may utilize that information to determine a predetermined threshold that a data set may not exceed. The identifier field may be assigned a value dynamically, based on the source from which the data originates. The identifier field may also be controlled by a user as the user selects the mode for the communication system. The time the data set expires may be based on the selected mode. In an embodiment, the mode may be selected by a user. In another embodiment, the mode may be selected dynamically based on network conditions.

In the embodiment as shown in FIG. 7, at step 710 the time stamp is reviewed. At step 720, the identifier field may be examined. The identifier field may be associated with a particular group. The group may be associated with a predetermined threshold time period. The expiration time of the data set may depend on which group the data set belongs.

At step 730, the difference in value between the time stamp value and the current time may be calculated. At step 740, the difference in value between the time stamp and the current time may be compared to the predetermined threshold for the group the data set belongs. If the difference in value between the time stamp and the current time is less than the predetermined threshold, the flow diagram proceeds to step 750 and transmits the data set. If the difference in value between the time stamp and the current time is greater than the predetermined threshold, the flow diagram proceeds to step 760 and drops the data set from transmission. In an embodiment, the data set is dropped from the queue for transmission.

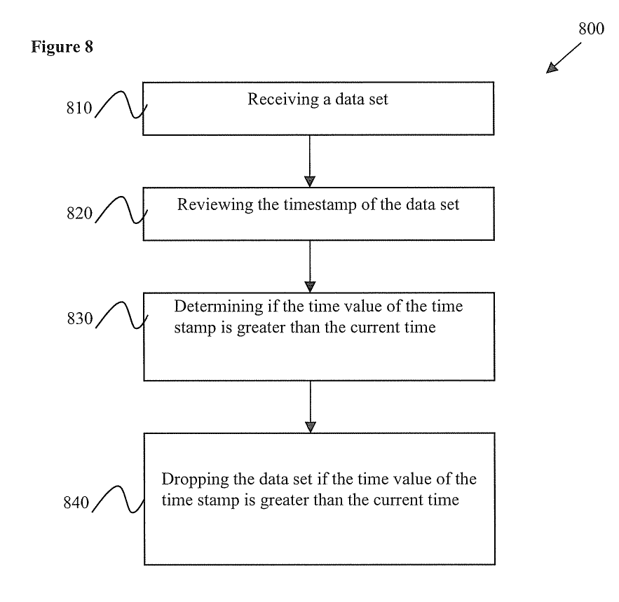

FIG. 8 illustrates a method 800 in accordance with an embodiment of the present invention. At step 810, a data set is received. At step 820, the time stamp of the data set is reviewed. In an embodiment, the current time of acquisition may be included in the timestamp of the data set. Alternatively, the timestamp of data set may include the “stale” time for the data set. The “stale” time may indicate the time in that the data set will become irrelevant, i.e. expires. The time the data set expires may be based on the selected mode. In an embodiment, the mode may be selected by a user. In another embodiment, the mode may be selected dynamically based on network conditions. In yet another alternative embodiment, the timestamp may include both the current time of acquisition and the “stale” time of the data set. In embodiment shown in method 800, the timestamp includes the “stale” time for the data set. At step 830, it is determined if the time value of the time stamp, and thus the “stale” time of the data set, is greater than the current time. At step 840, if the current time is greater than the time value of the time stamp, the data set has expired, and thus the data set is dropped.

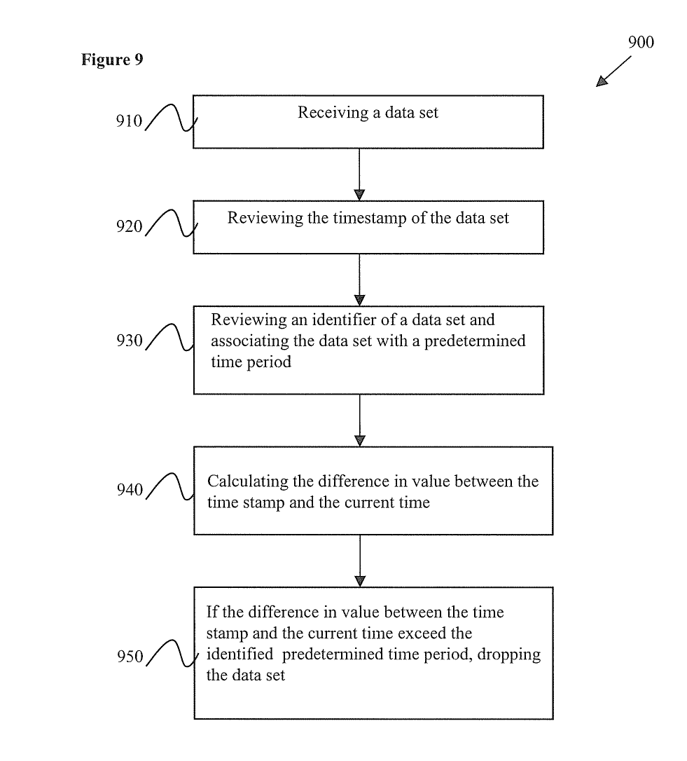

FIG. 9 illustrates a method 900 in accordance with an embodiment of the present invention. At step 910, a data set is received. At step 920, the time stamp of the data set is reviewed. In an embodiment, the current time of acquisition may be included in the timestamp of the data set. Alternatively, the timestamp of data set may include the “stale” time for the data set. The “stale” time may indicate the time in that the data set will become irrelevant. In yet another alternative embodiment, the timestamp may include both the current time of acquisition and the “stale” time of the data set. In embodiment shown in method 900, the timestamp includes the time of acquisition of the data set from the source.

At step 930, the data set may include a field for identifying which group the data set belongs. For example, if the data set belongs to a group having real time data, such as positional data, the expiration time of the data may be relatively short. If the data set belongs to a group having non-real time data, such as periodic status reports, the expiration time of the data may be relatively long. The identifier field of the data set may indicate to which group it belongs, and a receiver may utilize that information to determine a predetermined threshold that a data set may not exceed. The identifier field may be assigned a value dynamically, based on the source from which the data originates. The identifier field may also be controlled by a user as the user selects the mode for the communication system. At step 930, the identifier may be reviewed and the data set associated with a particular group, and thus a predetermined time period.

At step 940, the difference in value between the time stamp and the current time may be calculated. At step 950, if the difference in value between the time stamp and the current time is greater than the predetermined threshold the data set is dropped and not transmitted.

One or more of the steps of the methods 800 and 900 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of the methods 800 and 900 steps and/or perform the steps in a different order than the order listed. For example, some steps may not be performed in certain embodiments of the present invention. As a further example, certain steps may be performed in a different temporal order, including simultaneously, than listed above.

The system and method 800 described above may be carried out as part of a computer-readable storage medium including a set of instructions for a computer. The set of instructions may include a receiving routine for receiving a data set. In an embodiment, the current time of acquisition may be included in the timestamp of the data set. Alternatively, the timestamp of data set may include the “stale” time for the data set. The “stale” time may indicate the time in that the data set will become irrelevant. In yet another alternative embodiment, the timestamp may include both the current time of acquisition and the “stale” time of the data set. The set of instructions may also include a reviewing routing for reviewing a timestamp of the data set. The timestamp may be reviewed to determine the value of the timestamp. The set of instructions may also include a comparison routine to determine if the value of the timestamp is greater than the current time. The set of instructions may also include a dropping routine for dropping the data set if the current time exceeds the time value of the timestamp.

The system and method 900 described above may be carried out as part of a computer-readable storage medium including a set of instructions for a computer. The set of instructions may include a receiving routine for receiving a data set. The set of instructions may also include a reviewing routine for reviewing a timestamp of the data set. In an embodiment, the current time of acquisition may be included in the timestamp of the data set. Alternatively, the timestamp of data set may include the “stale” time for the data set. The “stale” time may indicate the time in that the data set will become irrelevant. In yet another alternative embodiment, the timestamp may include both the current time of acquisition and the “stale” time of the data set.

The set of instructions may also include an identification routine for reviewing an identifier of a data set and associating the data set with a predetermined time period. In an embodiment, the data set may include a field for identifying which group the data set belongs. For example, if the data set belongs to a group having real time data, such as positional data, the expiration time of the data may be relatively short. If the data set belongs to a group having non-real time data, such as periodic status reports, the expiration time of the data may be relatively long. The identifier field of the data set may indicate to which group it belongs, and a receiver may utilize that information to determine a predetermined threshold that a data set may not exceed. The identifier field may be assigned a value dynamically, based on the source from which the data originates. The identifier field may also be controlled by a user as the user selects the mode for the communication system. The identifier may be reviewed and the data set associated with a particular group, and thus a predetermined time period. The set of instructions may also include a comparison routine to determine if the value of the timestamp is greater than the current time. The set of instructions may also include a dropping routine for dropping the data set if the current time exceeds the time value of the timestamp.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for controlling the quality of service for data communication, the method comprising:
performing by at least one processing device:
receiving a data set, wherein said data set comprises a timestamp acquired prior to being received, said timestamp having a time value, wherein said timestamp represents a time said data set was generated, and wherein said time value is an expiration time of said data set;
reviewing said timestamp of said data set;
determining if said time value of said timestamp is greater than a current time; and
dropping said data set if said time value of said timestamp is greater than said current time.

2. The method of claim 1, wherein said step of dropping, includes dropping said data set from a queue.

3. The method of claim 1, wherein at least said steps of receiving, reviewing and determining occur at least one of:
in a transport layer of a network communications protocol stack of a data communication system, and
at a top of the transport layer of the network communications protocol stack of the data communication system.

4. The method of claim 1, wherein said expiration time of said data set is based on a selected mode.

5. The method of claim 4, wherein said selected mode is selected by a user.

6. The method of claim 4, wherein said selected mode is selected dynamically based on network conditions.

7. The method of claim 1, wherein said current time is a performance time of said determining step.

8. A method for controlling the quality of service for data communication, the method comprising:
performing by at least one processing device:
receiving a data set, wherein said data set comprises a timestamp acquired prior to being received, and wherein said timestamp comprises a time value representing a time said data set was generated;
reviewing said timestamp of said data set;
reviewing an identifier of said data set for associating said data set with one of a plurality of groups, each of said groups being associated with a predetermined threshold time value;
calculating a difference between said time value of said timestamp and a current time; and
dropping said data set if said difference between said time value of said time-stamp and said current time exceeds said predetermined threshold time value.

9. The method of claim 8, wherein said step of dropping, includes dropping said data set from a queue.

10. The method of claim 8, wherein said current time is a performance time of said calculating step.

11. The method of claim 8, wherein said time value is an acquisition time of said data set.

12. The method of claim 8, wherein said predetermined threshold time value is determined by a selected mode.

13. The method of claim 12, wherein said selected mode is selected by a user.

14. The method of claim 12, wherein said selected mode is selected dynamically based on network conditions.

15. The method of claim 8, wherein each of said groups represent a data type.

16. The method of claim 8, wherein said identifier identifies a source node of said data set.

17. The method of claim 8, wherein said timestamp includes an acquisition time of said data set and an expiration time of said data set.

18. A computer-readable medium encoded with a set of instructions for execution on a processing device, said set of instructions comprising:
a receiving routine for receiving a data set, wherein said data set comprises a timestamp acquired prior to being received, said timestamp having a time value, wherein said timestamp represents a time said data set was generated, and wherein said time value is an expiration time of said data set;
a reviewing routine for reviewing a timestamp of a data set;
a comparing routine for determining if said time value of said timestamp is greater than a current time; and
a dropping routine for dropping said data set if said current time exceeds said time value of said timestamp.

19. The computer-readable medium encoded with said set of instructions of claim 18, wherein said expiration time of said data set is based on a selected mode.

20. The computer-readable medium encoded with said set of instructions of claim 18, wherein said current time is a performance time of said comparing routine.

21. The computer-readable medium encoded with said set of instructions of claim 18, wherein at least said receiving, reviewing and determining occur at least one of:
in a transport layer of a network communications protocol stack of a data communication system, and
at a top of the transport layer of the network communications protocol stack of the data communication system.

22. The method of claim 8, wherein at least said steps of receiving, reviewing said timestamp, reviewing said identifier, and calculating occur at least one of:
in a transport layer of a network communications protocol stack of a data communication system, and
at a top of the transport layer of the network communications protocol stack of the data communication system.
